(19) United States
(12) Patent Application Publication
(10) Pub. No.: US 2017/0137091 A1
(43) Pub. Date: May 18, 2017

(54) DEVICE CAPABLE OF IMMEDIATELY LOCKING AND RELEASING A ROPE WITHOUT PRESSING A SWITCH

(71) Applicant: Gordon CHIH, CHANGHUA HSIEN (TW)

(72) Inventor: Gordon CHIH, CHANGHUA HSIEN (TW)

(21) Appl. No.: 15/352,338

(22) Filed: Nov. 15, 2016

(30) Foreign Application Priority Data
Nov. 16, 2015 (TW) 104218359

(51) Int. Cl. B63B 21/08; B66D 5/00

(52) U.S. Cl. CPC B63B 21/08; B66D 5/00

(57) ABSTRACT

A device capable of immediately locking and releasing a rope without pressing a switch includes two side plates connected with each other to form a case having an internal space. The case has a communication section for a rope to access the case. The case includes: an abutment section fixedly disposed on inner face of one of the side plates; a rotatable cam pivotally disposed on inner face of one of the side plates corresponding to the abutment section, the rotatable cam having an engagement surface and a first linking section; a first elastic body disposed between the side plate and the cam; a rotatable actuation section pivotally disposed on inner face of one of the side plates corresponding to one end of the cam, one end of the actuation section having a second linking section; and a second elastic body disposed between the side plate and the actuation section.

### BACKGROUND OF THE INVENTION

1. Field of the Invention

The present invention relates generally to a device capable of grasping a rope, and more particularly to a device capable of immediately locking and releasing a rope without pressing a switch.

2. Description of the Related Art

There are two kinds of conventional devices used in a sailboat for grasping a rope. One is a cam cleat capable of simply grasping a rope. The other is a clutch capable of releasing the rope with the rope still loaded. With respect to the cam cleat, only one end of the cam cleat is fixed so that the lifetime of the cam cleat is shortened and the holding force is relatively small. The clutch has a handle. The operation amplitude for shifting the handle is about 180° so that the use of the clutch is not so convenient.

A conventional article-lifting device generally employs a rope wound over fixed pulleys or a combination of fixed pulleys and movable pulleys for lifting an article. The conventional article-lifting device is further equipped with a rope-locking structure for immediately locking and releasing the rope. For example, U.S. Pat. No. 6,685,171 discloses a device having a pulley, a rotatable pawl and an engagement face for immediately locking the rope when lifting an article. An arm outward extends from the pawl by a certain length. When the article is lowered and the rope is swung and biased to force the arm, the rope is immediately locked. However, when lowering an article (releasing the rope), the pawl will get close to the engagement face. In this case, during the releasing of the rope, the article can be hardly smoothly lowered.

U.S. Pat. Nos. 7,428,769 and 8,141,212 disclose a conventional aiding tool for locking a rope or binding a tensioned rope. The tool has a case. A V-shaped channel is formed on outer face of the case. The inner wall of the V-shaped channel has multiple oblique ridge sections arranged in parallel to each other. When a tensioned rope accesses the case, the exposed rope can be plugged and engaged in the V-shaped channel to bind the rope. Such structure is able to quickly and easily bind a tensioned rope. However, it is unable to bind an over-tensioned rope. Moreover, after fixed, the rope will occasionally slip out of the V-shaped channel. For example, it often takes place that an article on a truck is tied by the aforesaid aiding tool and when the truck runs, the article is shocked to lead to loosening of the rope.

### SUMMARY OF THE INVENTION

It is therefore a primary object of the present invention to provide a device capable of immediately locking and releasing a rope without pressing a switch. The device is able to smoothly and safely lift and release a heavy article.

It is a further object of the present invention to provide the above device capable of immediately locking and releasing a rope without pressing a switch. The device can better keep the rope in a locked state.

It is still a further object of the present invention to provide the above device capable of immediately locking and releasing a rope without pressing a switch. The device can be used to pull and tension a rope.

To achieve the above and other objects, the device capable of immediately locking and releasing a rope without pressing a switch of the present invention at least includes two side plates mated and connected with each other to form a case having an internal space. The case has a communication section for a rope to access the case. The case at least includes therein an abutment section, a rotatable cam, a first elastic body, a rotatable actuation section and a second elastic body. The abutment section is fixedly disposed at a middle portion of inner face of one of the side plates. The rotatable cam is pivotally disposed on inner face of one of the side plates corresponding to the abutment section. The rotatable cam has an engagement surface and a first linking section. The first elastic body is disposed between the side plate and the cam. The rotatable actuation section is pivotally disposed at one end of inner face of one of the side plates corresponding to one end of the cam. One end of the actuation section has a second linking section corresponding to the first linking section. The second elastic body is disposed between the side plate and the actuation section.

The present invention can be best understood through the following description and accompanying drawings, wherein:

### BRIEF DESCRIPTION OF THE DRAWINGS

FIG. 1 is a perspective assembled view of a first embodiment of the present invention;

FIG. 2 is a perspective exploded view of the first embodiment of the present invention;

FIG. 3 is a front view of the first embodiment of the present invention with one of the side plates removed, showing that the engagement surface is positioned in the first position;

FIG. 4 is a front view of the first embodiment of the present invention with one of the side plates removed, showing that the engagement surface is positioned in the second position;

FIG. 5 is a front view of the first embodiment of the present invention with one of the side plates removed, showing that the actuation section is forced by a rope to swing;

FIG. 6 is a perspective exploded view of the first embodiment of the present invention, showing that the rope is a flat rope or strap;

FIG. 7 is a front view of the first embodiment of the present invention according to FIG. 4, showing another usage thereof;

FIG. 8 is a perspective exploded view of a second embodiment of the present invention; and

FIG. 9 is a front view of the second embodiment of the present invention with one of the side plates removed, showing that the engagement surface is positioned in the second position.

### DETAILED DESCRIPTION OF THE PREFERRED EMBODIMENTS

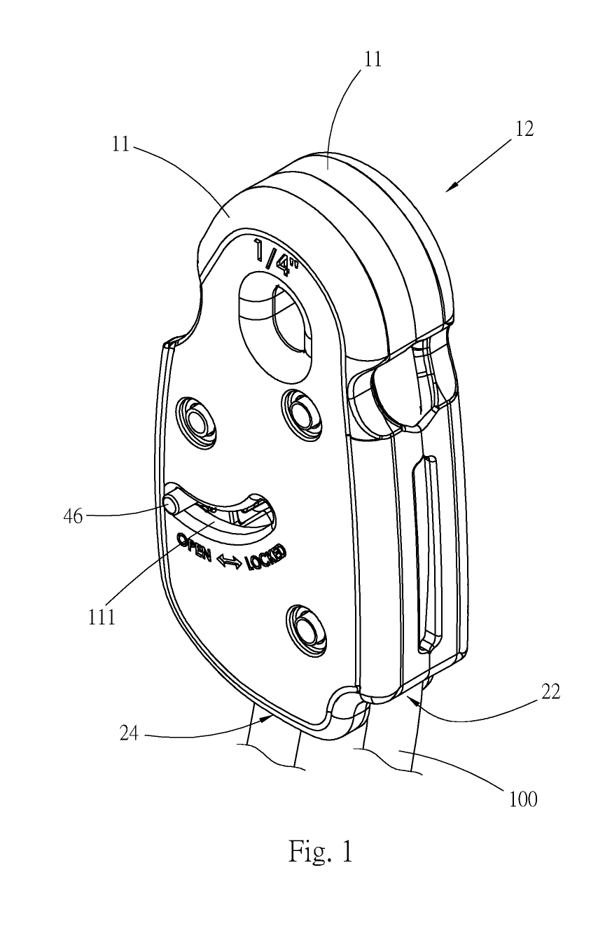

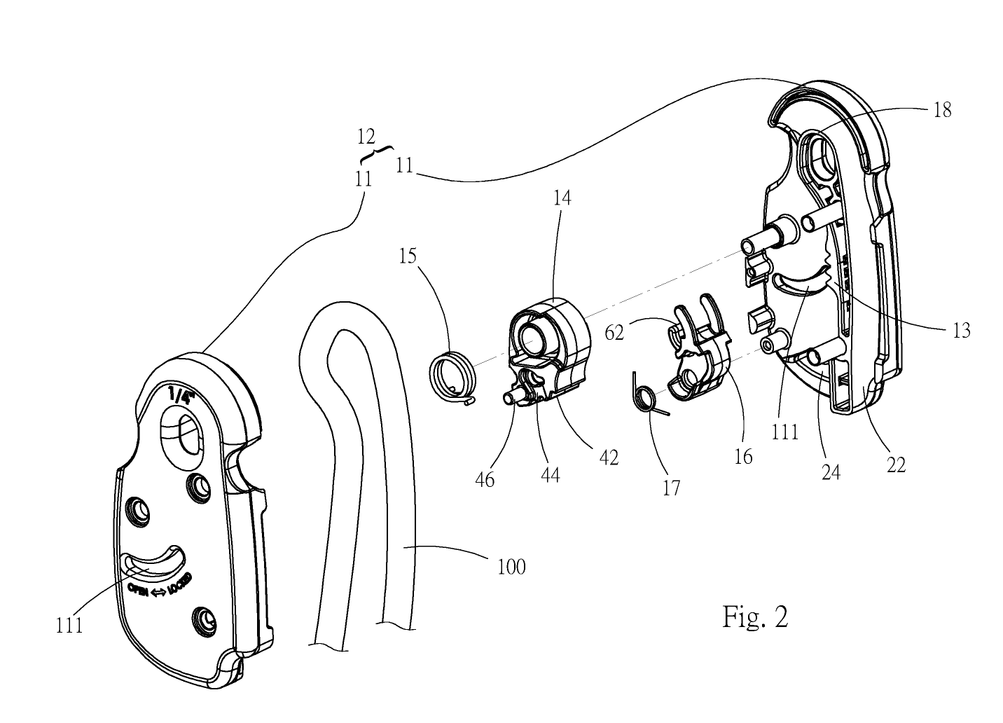

Please refer to FIGS. 1 to 5. The device capable of immediately locking and releasing a rope without pressing a switch of the present invention at least includes two side plates 11. The two side plates 11 are mated and connected with each other to form a case 12 having an internal space. The case 12 at least includes two openings 22, 24 for a rope 100 to access the case 12. The case 12 at least includes an abutment section 13, a rotatable cam 14, a first elastic body 15, a rotatable actuation section 16 and a second elastic body 17.

The abutment section 13 is fixedly disposed on a middle portion of inner face of one of the side plates 11. The abutment section 13 can be a roughened face. Alternatively, the abutment section 13 can be formed of at least one ratchet, whereby the abutment section 13 can provide greater stop frictional force.

The rotatable cam 14 is pivotally disposed on inner face of one of the side plates 11 corresponding to the abutment section 13. The rotatable cam 14 has an engagement surface 42 and a first linking section 44. The engagement surface 42 is correspondingly spaced from the abutment section 13 and swingable between a first position and a second position. The first linking section 44 is disposed at one end of the cam 14. The cam 14 is eccentrically pivotally connected with the side plate 11, whereby a variable gap is defined between the abutment section 13 and the engagement surface 42. In other words, the cam 14 and the abutment section 13 form a cam cleat. The engagement surface 42 can be formed of at least one ratchet, whereby the engagement surface 42 can provide greater stop frictional force. The first linking section 44 can be a recess.

The first elastic body 15 is such as a torque spring disposed between the side plate 11 and the cam 14. The first elastic body 15 serves to make the engagement surface 42 swing toward the abutment section 13 so as to hold the rope 100 positioned between the abutment section 13 and the engagement surface 42.

The rotatable actuation section 16 is pivotally disposed at one end of inner face of one of the side plates 11 corresponding to one end of the cam 14. The rotatable actuation section 16 is swingable between a third position and a fourth position. One end of the actuation section 16 has a second linking section 62 corresponding to the first linking section 44. The actuation section 16 is eccentrically pivotally connected with the side plate 11. A U-shaped block body outward extends from one end of the actuation section 16 to form the second linking section 62.

The second elastic body 17 is such as a torque spring disposed between the side plate 11 and the actuation section 16. The second elastic body 17 serves to make the actuation section 16 swing toward the abutment section 13.

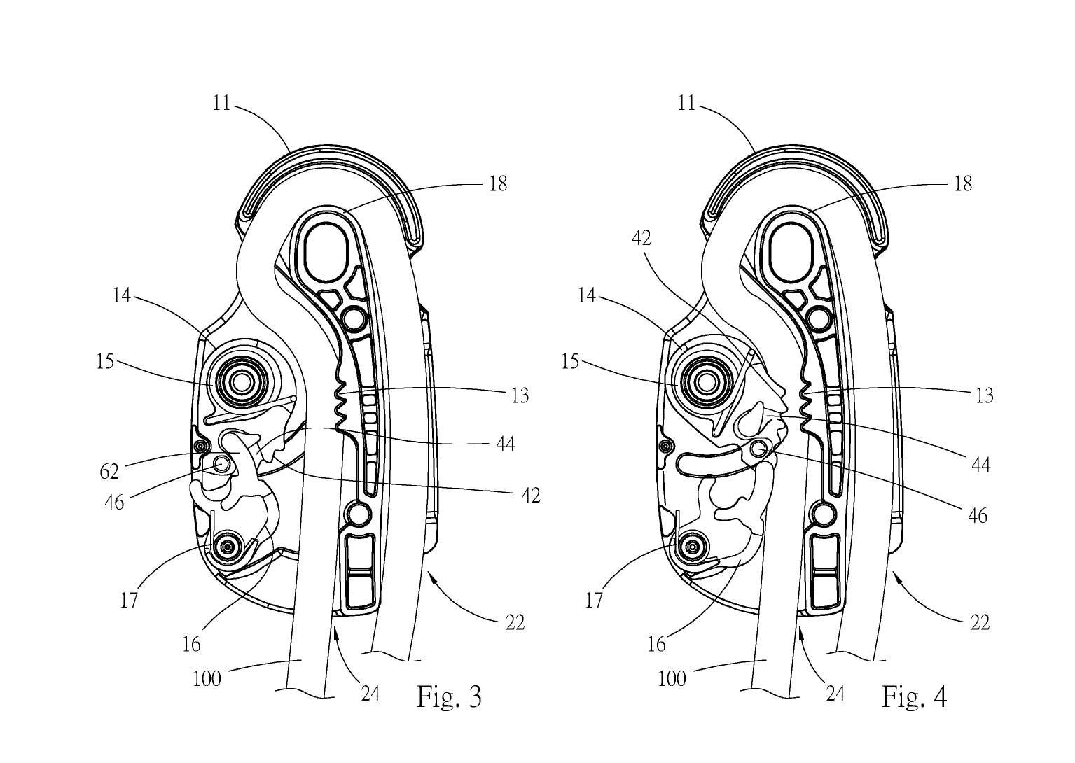

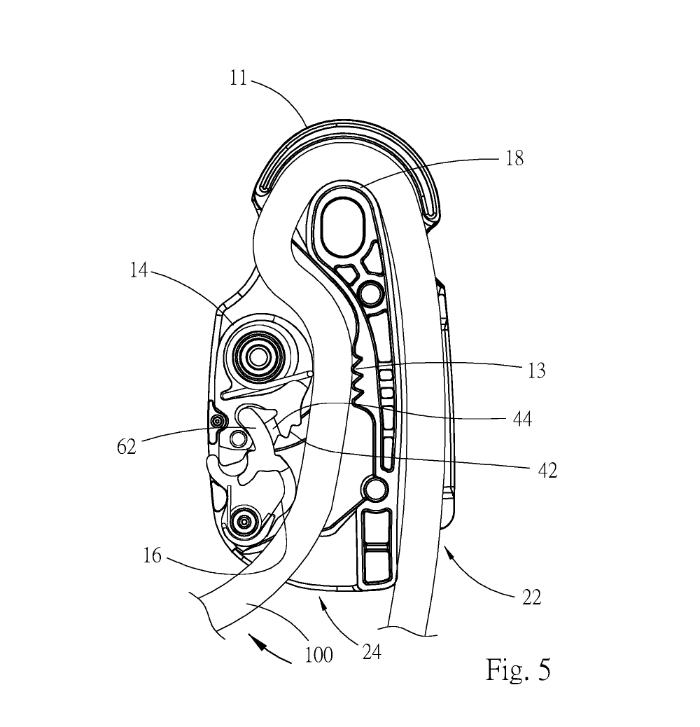

The cam 14 and the actuation section 16 are located in the following manner:
(A) As shown in FIG. 3, when the cam 14 is driven by a first external force, for example, a protrusion rod 46 outward extends from the cam 14 and an operator's hand forces the protrusion rod 46, the engagement surface 42 of the cam 14 swings in a direction away from the abutment section 13. At this time, the engagement surface 42 is positioned in the first position, whereby the space between the engagement surface 42 and the abutment section 13 permits the rope 100 to pass through the space and freely move within the space. Furthermore, when the cam 14 is driven, the first linking section 44 of the cam 14 is linked with the second linking section 62 of the actuation section 16 to drive the actuation section 16 to swing in a direction away from the abutment section 13. At this time, the actuation section 16 is positioned in the third position.
(B) As shown in FIG. 4, further to the operation of FIG. 3, when the cam 14 and the actuation section 16 are free from the external force, the first elastic body 15 makes the engagement surface 42 of the cam 14 swing toward the abutment section 13. At this time, the engagement surface 42 is positioned in the second position, whereby the engagement surface 42 and the abutment section 13 together hold a segment of the rope 100 positioned in the space, but permit the rope 100 positioned in the space to one-way slide. Furthermore, the second elastic body 17 makes the actuation section 16 swing toward the abutment section 13. At this time, the actuation section 16 is positioned in the fourth position.
(C) As shown in FIG. 5, when a second external force is applied to the rope 100 positioned in the space, for example, an operator's hand forces a segment of the rope 100 positioned between the engagement surface 42 and the abutment section 13 to move toward the actuation section 16, the rope 100 drives the engagement surface 42 of the cam 14 to swing in a direction away from the abutment section 13 and drives the actuation section 16 to swing in a direction away from the abutment section 13. At this time, the second linking section 62 of the actuation section 16 is linked with the first linking section 44 of the cam 14. Under such circumstance, the space between the engagement surface 42 and the abutment section 13 permits the rope 100 to freely move.

The device capable of immediately locking and releasing a rope without pressing a switch of the present invention can further include a seat section 18. The seat section 18 is disposed at one end of inner face of one of the side plates 11 opposite to the actuation section 16. The rope 100 can be partially wound over one side of the seat section 18, whereby the rope 100 is bent and supported in the case 12. Also, the rope 100 can access the case 12 from the same side and two ends of the rope 100 are forced on the same side. This is a better aid tool for pulling up and hanging a heavy article. Especially, in the case that the seat section 18 is a pulley, the present invention can provide strength-saving effect.

Referring to FIG. 4, when the present invention is fixed in a position and the other segment of the rope 100 has a load, for example, one end of the rope 100 at the opening 22 is connected with a heavy article, an operator can apply a force to the segment of the rope 100 positioned between the engagement surface 42 and the abutment section 13 to safely pull up the heavy article. When the operator desires to take a rest and stops forcing the rope 100 or releases the rope 100, the engagement surface 42 and the abutment section 13 immediately hold the rope 100 so that the heavy article will not drop down to cause danger.

Moreover, by means of the force application manner as shown in FIG. 5, an operator can immediately and easily place down the heavy article. Similarly, when the operator desires to take a rest or incautiously fails to hold the rope 100, the engagement surface 42 and the abutment section 13 will immediately hold the rope 100 so that the heavy article will not drop down to cause danger.

It should be especially noted that the second linking section 62 of the actuation section 15 can be linked with the first linking section 44 of the cam 14. As shown in FIG. 5, when on one hand, a force is applied to the segment of the rope 100 between the engagement surface 42 and the abutment section 13 to move the segment toward the actuation section 16 and on the other hand, the rope 100 is released to lower the heavy article, the biased and bent rope 100 presses the actuation section 16 and positions the actuation section 16 in the third position. Under such circumstance, the cam 14 is restricted by the actuation section 16, whereby the engagement surface 42 is positioned in the first position and separated from the abutment section 13. Accordingly, the rope 100 can be more smoothly released.

In the device capable of immediately locking and releasing a rope without pressing a switch of the present invention, the abutment section 13 is formed of at least one inclined ratchet, whereby the present invention can hold the rope 100, permitting the rope 100 to one-way slide.

In the device capable of immediately locking and releasing a rope without pressing a switch of the present invention, the engagement surface 42 is formed of at least one inclined ratchet, whereby the present invention can hold the rope 100, permitting the rope 100 to one-way slide.

In the device capable of immediately locking and releasing a rope without pressing a switch of the present invention, the first external force can be applied to the protrusion rod 46 of the cam 14. The protrusion rod 46 extends through an elongated arched slot 111 formed on one or both of the side plates 11 and is exposed to outer side. Character marks such as “open” and “locked” are marked on outer face beside the elongated arched slot 111 for respectively indicating the first and second positions of the engagement surface 42, to which the positions of the protrusion rod 46 correspond. Moreover, the protrusion rod 46 and the elongated arched slot 111 are such designed as to locate and guide the cam 14.

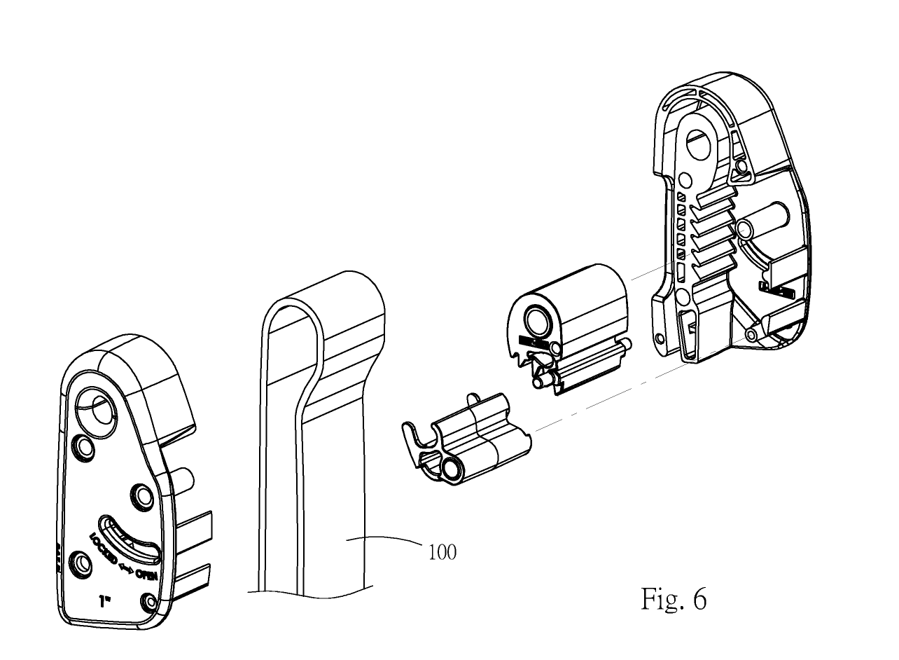

Please now refer to FIG. 6. In the device capable of immediately locking and releasing a rope without pressing a switch of the present invention, the rope 100 can be a flat rope or strap.

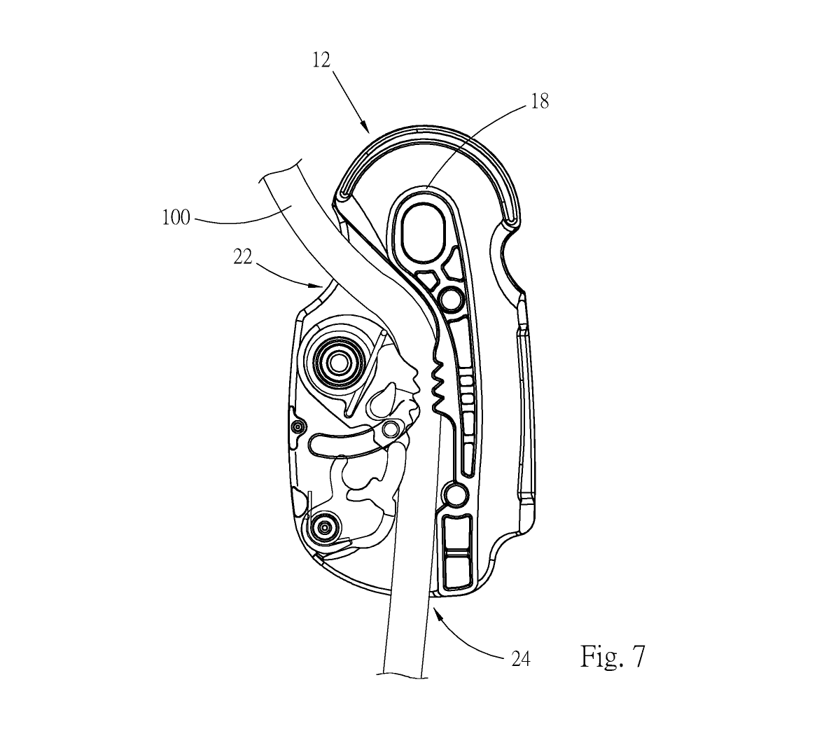

Please refer to FIG. 7. In the device capable of immediately locking and releasing a rope without pressing a switch of the present invention, the rope 100 can access the case 12 without being wound over the seat section 18. Under such circumstance, the rope 100 can be still pulled and tensioned. In this case, the two openings 22, 24 are arranged on different sides.

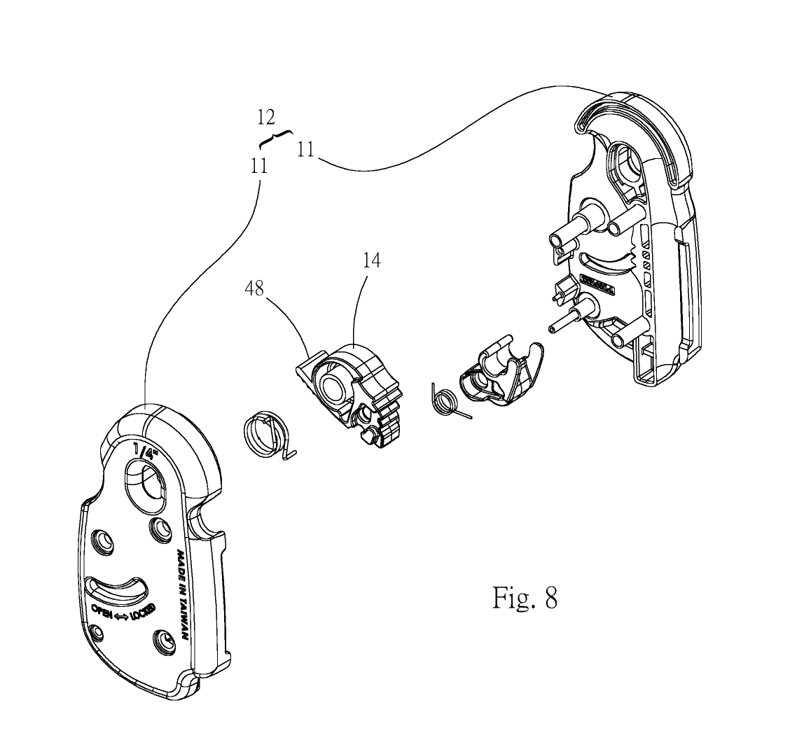

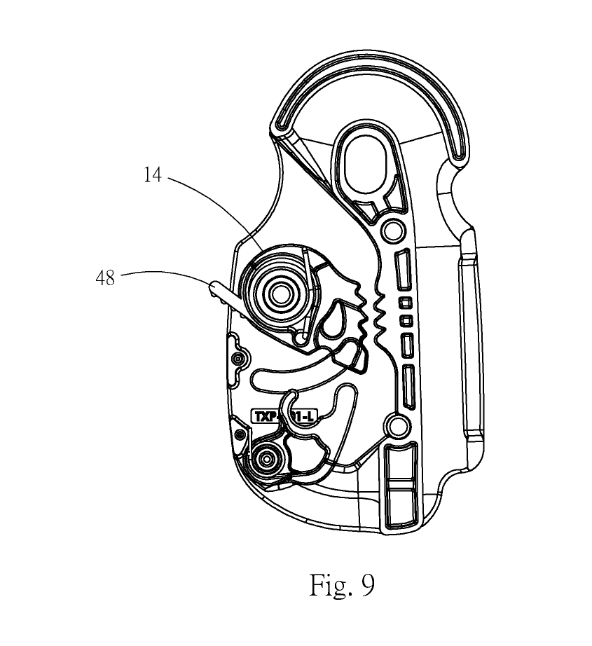

Please refer to FIGS. 8 and 9. In the device capable of immediately locking and releasing a rope without pressing a switch of the present invention, the first external force can be applied to the cam 14 in such a manner that an operator's finger extends into an opening on one side of the case 12 to shift the cam 14 or shift a tongue section 48 extending from the cam 14 to the opening on one side of the case 12.

Certainly, the present invention is fixed or fixedly hung for use.

The above embodiments are only used to illustrate the present invention, not intended to limit the scope thereof. Many modifications of the above embodiments can be made without departing from the spirit of the present invention.

What is claimed is:

1. A device capable of immediately locking and releasing a rope without pressing a switch, at least comprising two side plates, the two side plates being mated and connected with each other to form a case having an internal space, the case at least including a communication section for a rope to access the case, the case at least including:
an abutment section fixedly disposed on a middle portion of inner face of one of the side plates;
a rotatable cam pivotally disposed on inner face of one of the side plates corresponding to the abutment section, the rotatable cam having an engagement surface and a first linking section, the engagement surface being correspondingly spaced from the abutment section and swingable between a first position and a second position, the first linking section being disposed at one end of the cam;
a first elastic body disposed between the side plate and the cam, the first elastic body serving to make the engagement surface swing toward the abutment section;
a rotatable actuation section pivotally disposed at one end of inner face of one of the side plates corresponding to one end of the cam, the rotatable actuation section being swingable between a third position and a fourth position, one end of the actuation section having a second linking section corresponding to the first linking section; and
a second elastic body disposed between the side plate and the actuation section, the second elastic body serving to make the actuation section swing toward the abutment section, the cam and the actuation section being located in the following manner:
(1) when the cam is driven by a first external force, the engagement surface of the cam swings in a direction away from the abutment section and at this time, the engagement surface is positioned in the first position, whereby the space between the engagement surface and the abutment section permits the rope to pass through the space and freely move within the space;
(2) when the cam and the actuation section are free from the external force, the first elastic body makes the engagement surface of the cam swing toward the abutment section and at this time, the engagement surface is positioned in the second position, whereby the engagement surface and the abutment section together hold the rope positioned in the space, but permit the rope positioned in the space to one-way slide; and
(3) when a second external force is applied to the rope positioned in the space, the rope drives the engagement surface of the cam to swing in a direction away from the abutment section and drives the actuation section to swing in a direction away from the abutment section and at this time, the second linking section of the actuation section is linked with the first linking section of the cam, whereby the space between the engagement surface and the abutment section permits the rope to freely move.

2. The device capable of immediately locking and releasing a rope without pressing a switch as claimed in claim 1, wherein in (1) of the location of the cam and the actuation section, the first linking section of the cam is further linked with the second linking section of the actuation section to drive the actuation section to swing in a direction away from the abutment section and at this time, the actuation section is positioned in the third position, in (2) of the location of the cam and the actuation section, the second elastic body further makes the actuation section swing toward the abutment section and at this time, the actuation section is positioned in the fourth position, and at least one ratchet is formed of being selected from a group consisting of the abutment section, the engagement surface and the foregoing both.

3. The device capable of immediately locking and releasing a rope without pressing a switch as claimed in claim 1, wherein one or both of the cam and the actuation section are eccentrically pivotally connected with the side plate.

4. The device capable of immediately locking and releasing a rope without pressing a switch as claimed in claim 2, wherein one or both of the cam and the actuation section are eccentrically pivotally connected with the side plate.

5. The device capable of immediately locking and releasing a rope without pressing a switch as claimed in claim 1, wherein the first linking section is a recess, while the second linking section is formed of a U-shaped block body outward extending from one end of the actuation section.

6. The device capable of immediately locking and releasing a rope without pressing a switch as claimed in claim 2, wherein the first linking section is a recess, while the second linking section is formed of a U-shaped block body outward extending from one end of the actuation section.

7. The device capable of immediately locking and releasing a rope without pressing a switch as claimed in claim 3, wherein the first linking section is a recess, while the second linking section is formed of a U-shaped block body outward extending from one end of the actuation section.

8. The device capable of immediately locking and releasing a rope without pressing a switch as claimed in claim 4, wherein the first linking section is a recess, while the second linking section is formed of a U-shaped block body outward extending from one end of the actuation section.

9. The device capable of immediately locking and releasing a rope without pressing a switch as claimed in claim 1, wherein the first elastic body is a torque spring and the second elastic body is also a torque spring.

10. The device capable of immediately locking and releasing a rope without pressing a switch as claimed in claim 2, wherein the first elastic body is a torque spring and the second elastic body is also a torque spring.

11. The device capable of immediately locking and releasing a rope without pressing a switch as claimed in claim 3, wherein the first elastic body is a torque spring and the second elastic body is also a torque spring.

12. The device capable of immediately locking and releasing a rope without pressing a switch as claimed in claim 4, wherein the first elastic body is a torque spring and the second elastic body is also a torque spring.

13. The device capable of immediately locking and releasing a rope without pressing a switch as claimed in claim 1, wherein the communication section is formed of two openings disposed on the case.

14. The device capable of immediately locking and releasing a rope without pressing a switch as claimed in claim 2, wherein the communication section is formed of two openings disposed on the case.

15. The device capable of immediately locking and releasing a rope without pressing a switch as claimed in claim 3, wherein the communication section is formed of two openings disposed on the case.

16. The device capable of immediately locking and releasing a rope without pressing a switch as claimed in claim 4, wherein the communication section is formed of two openings disposed on the case.

17. The device capable of immediately locking and releasing a rope without pressing a switch as claimed in claim 1, wherein a protrusion rod outward extends from the cam.

18. The device capable of immediately locking and releasing a rope without pressing a switch as claimed in claim 2, wherein a protrusion rod outward extends from the cam.

19. The device capable of immediately locking and releasing a rope without pressing a switch as claimed in claim 3, wherein a protrusion rod outward extends from the cam.

20. The device capable of immediately locking and releasing a rope without pressing a switch as claimed in claim 4, wherein a protrusion rod outward extends from the cam.
